(19) United States
(12) Patent Application Publication
(10) Pub. No.: US 2026/0112911 A1
(43) Pub. Date: Apr. 23, 2026

(54) SYSTEM AND METHOD FOR DISSIPATING ENERGY STORED IN BATTERY SYSTEM

(71) Applicant: Caterpillar Inc., Peoria, IL (US)

(72) Inventors: Karthikeyan Kottaisamy, Ramanathapuram (IN); Souvik Das, Bangalore (IN); Malay Bhunia, Paschim Medinipur (IN); Umesh BS, Tumakuru (IN); Aravinth Manivannan, Bengaluru (IN)

(73) Assignee: Caterpillar Inc., Peoria, IL (US)

(21) Appl. No.: 18/922,583

(22) Filed: Oct. 22, 2024

(51) Int. Cl. H02J 7/00; H01M 10/42; H01M 10/48

(52) U.S. Cl. CPC H02J 7/933; H01M 10/425; H01M 10/48; H02J 7/40; H02J 7/82; H02J 7/855; H01M 2010/4271; H02J 2207/20

(57) ABSTRACT

A system for dissipating energy stored in a battery system includes a direct current (DC)-DC converter, an active front end (AFE), and a controller including one or more memories and one or more processors. The one or more processors are configured to determine a current state of charge (SOC) of the battery system; retrieve, from the one or more memories, the minimum energy value to be maintained in the battery system; compare the current SOC of the battery system with the minimum energy value; and dissipate the energy stored in the battery system if the current SOC is greater than the minimum energy value through the DC-DC converter, the AFE, both of the DC-DC converter and the AFE, and/or both of a first semiconductor device of the DC-DC converter and a second semiconductor device of the AFE.

### TECHNICAL FIELD

The present disclosure relates to a battery system, and more particularly, to a system for dissipating energy stored in the battery system and a method for dissipating energy stored in the battery system.

### BACKGROUND

A battery system is often used in a variety of applications as a means of power supply. For example, battery systems are being increasingly implemented in passenger vehicles, machines, and the like, to supply electric energy.

Typically, electric energy stored in off-board (outside the machine) battery systems need to be dissipated/discharged to a desired state of charge (SOC) for facilitating transport of the battery system. In an example, in order to transport the battery system, the SOC of the battery system must be in a range of 20-30%. Currently, multiple resistors and contactors are used to attain variable discharge for the battery system. Multiple resistors and contactors may be arranged in a single pathway to dissipate the energy stored in the battery system. Specifically, multiple resistors are connected directly to terminals of the battery system to dissipate the electric energy from the battery system.

U.S. Pat. No. 11,695,323 describes systems, apparatuses, and methods for discharging an input voltage by utilizing discharge circuitry configured to produce a relatively constant discharge voltage value/output voltage, a relatively constant discharge current value/output current, or a relatively constant discharge power value/output power. The discharge circuitry may include at least one power device, such as a DC to DC converter.

### SUMMARY OF THE DISCLOSURE

In an aspect of the present disclosure, a system for dissipating energy stored in a battery system is provided. The system includes a direct current (DC)-DC converter coupled with the battery system. The DC-DC converter includes a first semiconductor device. The system also includes an active front end (AFE) coupled with the battery system and the DC-DC converter. The AFE includes a second semiconductor device. The system further includes a controller including one or more memories and one or more processors communicably coupled to the one or more memories. The one or more memories are configured to store a minimum energy value that is to be maintained in the battery system. The one or more processors are configured to determine a current state of charge (SOC) of the battery system. The one or more processors are also configured to retrieve, from the one or more memories, the minimum energy value that is to be maintained in the battery system. The one or more processors are further configured to compare the current SOC of the battery system with the minimum energy value. The one or more processors are configured to dissipate the energy stored in the battery system if the current SOC is greater than the minimum energy value through at least one of the DC-DC converter, the AFE, both of the DC-DC converter and the AFE, and both of the first semiconductor device of the DC-DC converter and the second semiconductor device of the AFE.

In another aspect of the present disclosure, a method for dissipating energy stored in a battery system is provided. The method includes determining, by one or more processors of a controller, a current state of charge (SOC) of the battery system. The method also includes retrieving, from one or more memories of the controller, a minimum energy value that is to be maintained in the battery system. The one or more memories are communicably coupled to the one or more processors. The method further includes comparing, by the one or more processors, the current SOC of the battery system with the minimum energy value. The method includes controlling, by the one or more processors, dissipation of the energy stored in the battery system if the current SOC is greater than the minimum energy value through at least one of a direct current DC-DC converter that is coupled with the battery system, an active front end (AFE) that is coupled with the battery system and the DC-DC converter, both of the DC-DC converter and the AFE, and both of a first semiconductor device of the DC-DC converter and a second semiconductor device of the AFE.

In yet another aspect of the present disclosure, a controller for a battery system is provided. The controller includes one or more memories that are configured to store a minimum energy value that is to be maintained in the battery system. The controller also includes one or more processors communicably coupled to the one or more memories. The one or more processors are configured to perform the step of determining a current state of charge (SOC) of the battery system. The one or more processors are also configured to perform the step of retrieving, from the one or more memories, the minimum energy value that is to be maintained in the battery system. The one or more processors are further configured to perform the step of comparing the current SOC of the battery system with the minimum energy value. The one or more processors are configured to perform the step of controlling dissipation of energy stored in the battery system if the current SOC is greater than the minimum energy value through at least one of a direct current DC-DC converter that is coupled with the battery system, an active front end (AFE) that is coupled with the battery system and the DC-DC converter, both of the DC-DC converter and the AFE, and both of a first semiconductor device of the DC-DC converter and a second semiconductor device of the AFE.

Other features and aspects of this disclosure will be apparent from the following description and the accompanying drawings.

### BRIEF DESCRIPTION OF THE DRAWINGS

FIG. 1 is a block diagram of a system for dissipating energy stored in a battery system, according to an example of the present disclosure;

FIG. 2 is a block diagram of the system of FIG. 1 illustrating energy dissipation via a first semiconductor device and a second semiconductor device; and

FIG. 3 is a flowchart for a method for dissipating energy stored in the battery system of FIG. 1, according to an example of the present disclosure.

### DETAILED DESCRIPTION

Wherever possible, the same reference numbers will be used throughout the drawings to refer to the same or like parts.

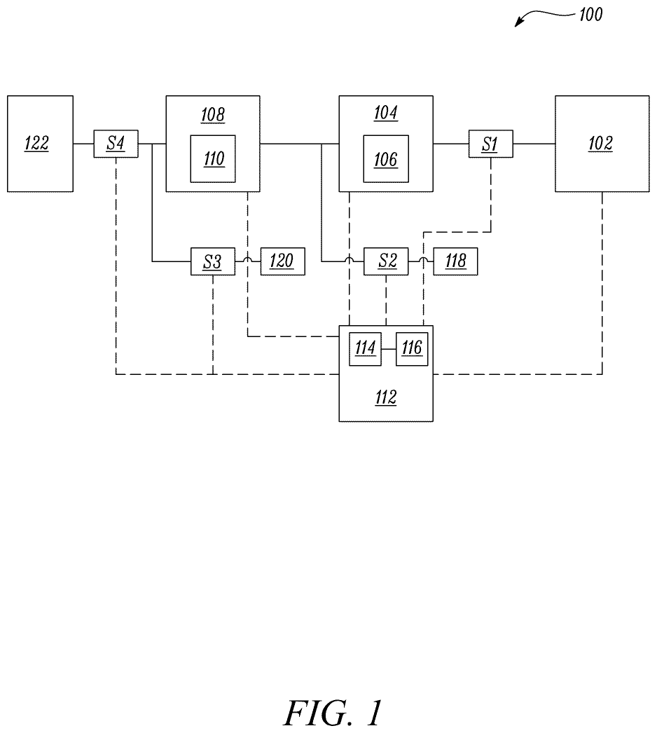

Referring to FIG. 1, a block diagram of a system 100 for dissipating energy stored in a battery system 102 is provided. The battery system 102 may be used in a variety of applications as a means of power supply. For example, the battery system 102 may be used in a machine, a passenger vehicle, and the like, to provide power supply to one or more components associated therewith. The machine may include a moving machine or a stationary machine. The machine may include a work machine or a construction machine, such as, a mining truck, a wheel loader, and the like.

In the illustrated example of FIG. 1, the battery system 102 is an off-board (outside the machine) battery system in which a minimum energy value needs to be maintained for transportation. In an example, the electric energy stored inside the battery system 102 may require to be in a range of 20% to 30% of a state of charge (SOC). The present disclosure relates to the system 100 for dissipating energy stored in the battery system 102, so that the battery system 102 can be transported as per regulations.

The system 100 includes a direct current (DC)-DC converter 104 coupled with the battery system 102. The DC-DC converter 104 may convert a flow of direct current (DC) from the battery system 102 from one voltage level to a desired voltage level. The DC-DC converter 104 may include a buck converter, a boost converter, a buck & boost converter, an isolating converter such as a flyback converter, a forward converter, and the like. The DC-DC converter 104 includes a first semiconductor device 106. It should be noted that the DC-DC converter 104 may include multiple first semiconductor devices 106. The first semiconductor device 106 may include an insulated-gate bipolar transistor (IGBT) switch or a metal-oxide-semiconductor field-effect transistor (MOSFET), without any limitations. The system 100 also includes a first switch S1. The first switch S1 couples the DC-DC converter 104 with the battery system 102. The first switch S1 may include, for example, a solenoid switch, a relay switch, a contactor switch, etc. It should be noted that, dotted lines in FIG. 1 represent communication lines between the components and solid lines represent electrical coupling between the components.

The system 100 further includes a first electric system 118 coupled with a DC-DC converter 104. Specifically, the first electric system 118 is coupled at a DC link side of the DC-DC converter 104. The first electric system 118 may store/use the energy being dissipated from the battery system 102. The first electric system 118 includes a DC discharge resistor bank or a DC load. In some examples, the DC load may include a DC motor, a DC lighting load, or any other type of useful load. In other examples, the first electric system 118 may embody a battery system.

The system 100 includes a second switch S2. The second switch S2 couples the DC-DC converter 104 with the first electric system 118. The second switch S2 may include, for example, a solenoid switch, a relay switch, a contactor switch, etc.

The system 100 further includes an active front end (AFE) 108 coupled with the battery system 102 and the DC-DC converter 104. The AFE 108 includes a second semiconductor device 110. It should be noted that the AFE 108 may include multiple second semiconductor devices 110. The second semiconductor device 110 may include an IGBT switch or a MOSFET, without any limitations. The system 100 further includes a second electric system 120 coupled with the AFE 108. The second electric system 120 may store/use the energy being dissipated from the battery system 102. The second electric system 120 includes an alternating current (AC) discharge resistor bank or an AC load. In some examples, the AC load may include an AC motor, an AC lighting load, or any other type of useful load. In other examples, the second electric system 120 may embody a battery system. It should be noted that any type of AC load may be used instead of the AC discharge resistor bank using a grid forming mode of the AFE 108.

The system 100 includes a third switch S3 that couples the second electric system 120 with of the AFE 108. Specifically, the third switch S3 couples the second electric system 120 with an AC side of the AFE 108. The third switch S3 may include, for example, a solenoid switch, a relay switch, a contactor switch, etc.

The system 100 also includes a grid 122 coupled with the AFE 108. The system 100 further includes a fourth switch S4 that couples the grid 122 with the AFE 108. The fourth switch S4 may include, for example, a solenoid switch, a relay switch, a contactor switch, etc.

The system 100 further includes a controller 112. The controller 112 includes one or more memories 114 and one or more processors 116 communicably coupled to the one or more memories 114. The one or more memories 114 store the minimum energy value that is to be maintained in the battery system 102. It should be noted that the minimum energy value may be between 20% to 30% of the SOC of the battery system 102. The one or more memories 114 may include any means of storing information, including a hard disk, an optical disk, a floppy disk, ROM (read only memory), RAM (random access memory), PROM (programmable ROM), EEPROM (electrically erasable PROM), or other computer-readable memory media.

It should be noted that the one or more processors 116 may embody a single microprocessor or multiple microprocessors for receiving various input signals and generating output signals. Numerous commercially available microprocessors may perform the functions of the one or more processors 116. The one or more processors 116 may further include a general processor, a central processing unit, an application specific integrated circuit (ASIC), a digital signal processor, a field programmable gate array (FPGA), a digital circuit, an analog circuit, a microcontroller, any other type of processor, or any combination thereof. The one or more processors 116 may include one or more components that may be operable to execute computer executable instructions or computer code that may be stored and retrieved from the one or more memories 114.

The one or more processors 116 determine a current SOC of the battery system 102. The one or more processors 116 retrieve, from the one or more memories 114, the minimum energy value that is to be maintained in the battery system 102. Further, the one or more processors 116 compare the current SOC of the battery system 102 with the minimum energy value. Furthermore, the one or more processors 116 dissipate the energy stored in the battery system 102 if the current SOC is greater than the minimum energy value through one or more of the DC-DC converter 104, the AFE 108, both of the DC-DC converter 104 and the AFE 108, and both of the first semiconductor device 106 of the DC-DC converter 104 and the second semiconductor device 110 of the AFE 108.

In an example, the system 100 includes the first electric system 118 coupled with the DC-DC converter 104 to dissipate the energy through the DC-DC converter 104. In such an example, the one or more processors 116 direct the energy towards the first electric system 118. Further, in such an example, the one or more processors 116 dispose each of the first switch S1 and the second switch S2 in an open state to dissipate the energy, through the DC-DC converter 104, towards the first electric system 118. It should be noted that, in this example, the third switch S3 and the fourth switch S4 are disposed in a closed state. Further, the one or more processors 116 may control a dissipation rate via the DC-DC converter 104 such that the energy being dissipated from the battery system 102 is directed towards the first electric system 118 in a controlled manner. In some examples, the dissipation rate via the DC-DC converter 104 may be controlled by controlling a duty ratio of the DC-DC converter 104.

In another example, the system 100 includes the second electric system 120 to dissipate the energy through the AFE 108. In such an example, the one or more processors 116 direct the energy towards the second electric system 120. Further, in such an example, the one or more processors 116 dispose each of the first switch S1 in the open state and the third switch S3 in an open state to dissipate the energy, through the AFE 108, towards the second electric system 120. It should be noted that, in this example, the second switch S2 and the fourth switch S4 are disposed in a closed state. Further, the one or more processors 116 may control the dissipation rate via the AFE 108 by controlling a modulation index, a switching frequency, and a fundamental frequency of the AFE 108. Further, the energy dissipation may be based on an average output voltage of the AFE 108.

In yet another example, to dissipate the energy through both of the DC-DC converter 104 and the AFE 108, the one or more processors 116 direct a first portion of the energy from the battery system 102, through the DC-DC converter 104, towards the first electric system 118 and a second portion of the energy from the battery system 102, through the AFE 108, towards the second electric system 120. Specifically, the one or more processors 116 dispose each of the first switch S1, the second switch S2, and the third switch S3 in the open state to direct the first portion of the energy towards the first electric system 118 and the second portion of the energy towards the second electric system 120. It should be noted that, in this example, the switch S4 is disposed in the closed state. Further, the one or more processors 116 may control the dissipation rate via both of the DC-DC converter 104 and the AFE 108, such that the energy being dissipated may be directed towards the first electric system 118 and the second electric system 120 in a controlled manner.

In some examples, the one or more processors 116 control the fourth switch S4 to charge the battery system 102 through the grid 122 and/or to dissipate the energy stored in the battery system 102. Specifically, the one or more processors 116 dispose the fourth switch S4 in an open state to charge the battery system 102. Further, the fourth switch S4 is disposed in the closed state when energy is being dissipated through the DC-DC converter 104, the AFE 108, both of the DC-DC converter 104 and the AFE 108, and/or both of the first semiconductor device 106 of the DC-DC converter 104 and the second semiconductor device 110 of the AFE 108.

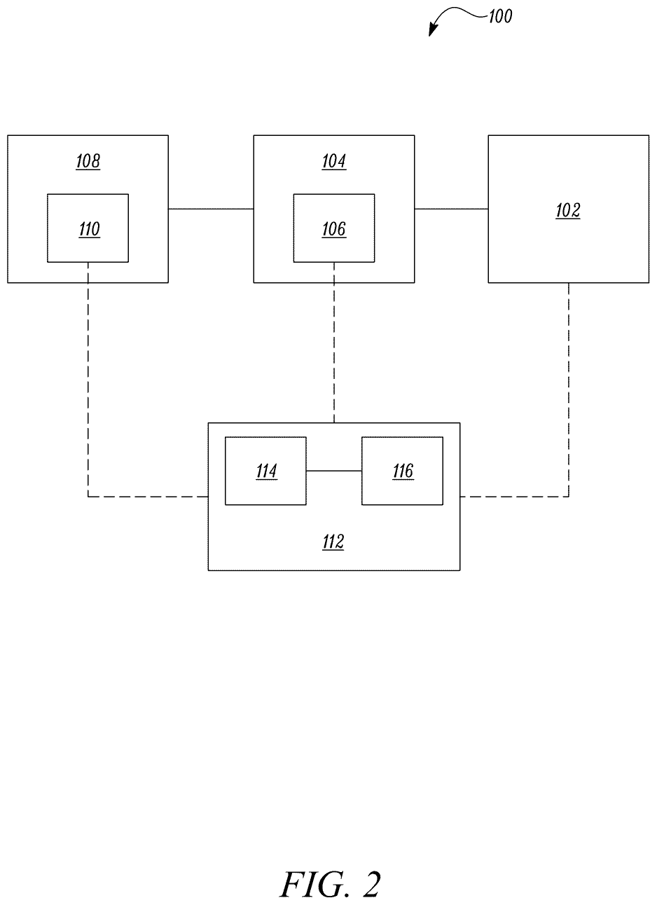

Referring to FIG. 2, a block diagram of the system 100 for dissipating energy stored in the battery system 102 through both of the first semiconductor device 106 and the second semiconductor device 110 is illustrated.

As is apparent from FIG. 2, to dissipate the energy through both of the first semiconductor device 106 of the DC-DC converter 104 and the second semiconductor device 110 of the AFE 108, the one or more processors 116 control both the first semiconductor device 106 and the second semiconductor device 110 to dissipate the energy stored in the battery system 102 through switching and conduction loss. Specifically, the energy stored in the battery system 102 is dissipated using the switching and conduction loss of the first and second semiconductor device 106, 110 by varying the switching frequency of the DC-DC converter 104 and the AFE 108. Further, the one or more processors 116 may control the dissipation rate through both the DC-DC converter 104 and the AFE 108 based on the conduction and switching losses of the first and second semiconductor device 106, 110.

It is to be understood that individual features shown or described for one embodiment may be combined with individual features shown or described for another embodiment. The above-described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure is related to the system 100 for dissipating energy stored in the battery system 102. The system 100 includes the controller 112. The controller 112 includes the one or more processors 116. The one or more processors 116 may control the dissipation rate of the energy stored in the battery system 102 without a need to reconfigure the first electric system 118 and the second electric system 120. In other words, the system 100 may eliminate reconfiguration of the DC resistor bank and/or the AC resistor bank to control the discharging of the battery system 102. The system 100 may regulate energy dissipation and may fine-tune the discharge rate of the battery system 102.

In some examples, the system 100 may dissipate the energy stored in the battery system 102 towards one or more battery systems connected with the DC-DC converter 104 and the AFE 108. Thus, the system 100 may allow charging of auxiliary batteries that may further be used for various applications.

Further, the system 100 may reduce a need of contactor switches to control the first electric system 118 and the second electric system 120. The system 100 includes the DC-DC converter 104 and the AFE 108. The DC-DC converter 104 includes the first semiconductor device 106 and the AFE 108 includes the second semiconductor device 110. Switching and conduction losses through both of the first and second semiconductor device 106, 110 may aid in discharging of the battery system 102 thereby, reducing a rating of a required external discharge resistor.

The system 100 allows active dissipation of energy stored in the battery system 102 without a need of an additional hardware. Further, the application of the system 100 may provide multiple discharging paths to dissipate the energy stored in the battery system 102 and may reduce a size/power of the first electric system 118 and the second electric system 120. Further, the system 100 may allow quick dissipation of energy stored in the battery system 102 up to the minimum energy value that is to be maintained in the battery system 102 that helps in transportation of the battery system 102, while abiding with regulations.

Overall, the system 100 is simple in design, as the system 100 does not include complex components. Moreover, the system 100 may be cost-effective and may be time efficient.

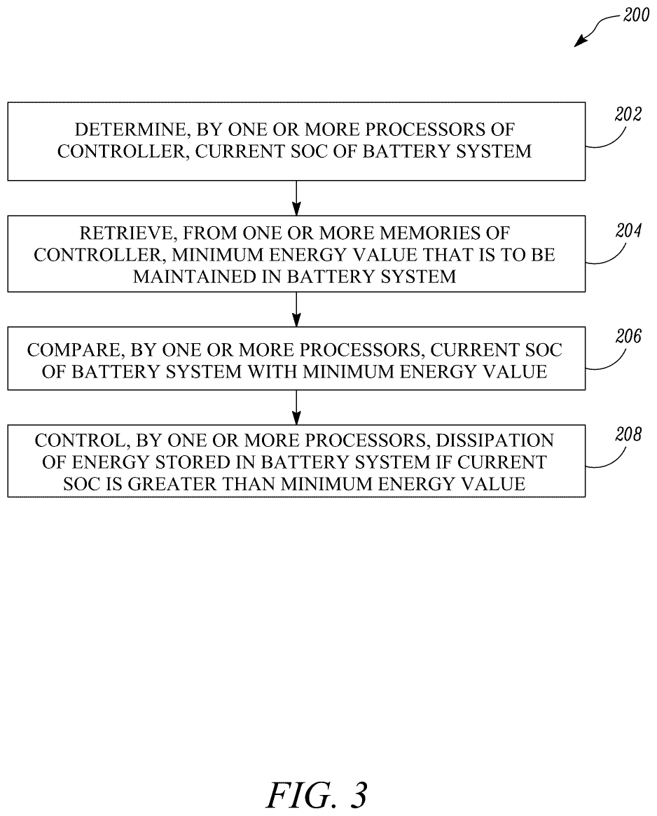

FIG. 3 is a flowchart for a method 200 for dissipating energy stored in the battery system 102. With reference to FIGS. 1 to 3, at a step 202, the one or more processors 116 of the controller 112 determine the current SOC of the battery system 102. The one or more processors 116 are communicably coupled to the one or more memories 114. At a step 204, the one or more processors 116 retrieve the minimum energy value that is to be maintained in the battery system 102 from the one or more memories 114 of the controller 112. At a step 206, the one or more processors 116 compare the current SOC of the battery system 102 with the minimum energy value.

Further, at a step 208, the one or more processors 116 control the dissipation of the energy stored in the battery system 102 if the current SOC is greater than the minimum energy value through the DC-DC converter 104 that is coupled with the battery system 102, the AFE 108 that is coupled with the battery system 102 and the DC-DC converter 104, both of the DC-DC converter 104 and the AFE 108, and/or both of the first semiconductor device 106 of the DC-DC converter 104 and the second semiconductor device 110 of the AFE 108.

The DC-DC converter 104 is coupled with the battery system 102 via the first switch S1. The DC-DC converter 104 is coupled with the first electric system 118 via the second switch S2. The method 200 further includes a step (not shown) at which the one or more processors 116 operate each of the first switch S1 and the second switch S2 in the open state. The method 200 further includes a step (not shown) at which the one or more processors 116 dissipate the energy, through the DC-DC converter 104, towards the first electric system 118 based on the operation of each of the first switch S1 and the second switch S2 in the open state.

The AFE 108 is coupled with the second electric system 120 via the third switch S3. The method 200 further includes a step (not shown) at which the one or more processors 116 operate the first switch S1 in the open state and the third switch S3 in the open state. The method 200 further includes a step (not shown) at which the one or more processors 116 dissipate the energy, through the AFE 108, towards the second electric system 120 based on the operation of each of the first switch S1 and the third switch S3 in the open state.

Further, the method 200 includes a step (not shown) at which the one or more processors 116 operate each of the first switch S1, the second switch S2, and the third switch S3 in the open state to direct the first portion of the energy, through the DC-DC converter 104, towards the first electric system 118 and the second portion of the energy, through the AFE 108, towards the second electric system 120.

It should be noted that the steps 202, 204, 206, 208 of the method 200 may be performed in a sequence that is different from that explained in relation to FIG. 3. Further, various steps 202, 204, 206, 208 can be performed together.

While aspects of the present disclosure have been particularly shown and described with reference to the embodiments above, it will be understood by those skilled in the art that various additional embodiments may be contemplated by the modification of the disclosed work machine, systems and methods without departing from the spirit and scope of the disclosure. Such embodiments should be understood to fall within the scope of the present disclosure as determined based upon the claims and any equivalents thereof.

What is claimed is:

1. A system for dissipating energy stored in a battery system, the system comprising:
a direct current DC-DC converter coupled with the battery system, wherein the DC-DC converter includes a first semiconductor device;
an active front end (AFE) coupled with the battery system and the DC-DC converter, wherein the AFE includes a second semiconductor device; and
a controller including one or more memories and one or more processors communicably coupled to the one or more memories, wherein the one or more memories are configured to store a minimum energy value that is to be maintained in the battery system, and wherein the one or more processors are configured to:
determine a current state of charge (SOC) of the battery system;
retrieve, from the one or more memories, the minimum energy value that is to be maintained in the battery system;
compare the current SOC of the battery system with the minimum energy value; and
dissipate the energy stored in the battery system if the current SOC is greater than the minimum energy value through at least one of:
the DC-DC converter,
the AFE,
both of the DC-DC converter and the AFE, and
both of the first semiconductor device of the DC-DC converter and the second semiconductor device of the AFE.

2. The system of claim 1 further including a first electric system coupled with the DC-DC converter to dissipate the energy through the DC-DC converter, wherein the one or more processors are configured to direct the energy towards the first electric system.

3. The system of claim 2, wherein the first electric system includes a DC discharge resistor bank or a DC load.

4. The system of claim 2 further including a second electric system coupled with the AFE to dissipate the energy through the AFE, wherein the one or more processors are configured to direct the energy towards the second electric system.

5. The system of claim 4, wherein the second electric system includes an alternating current (AC) discharge resistor bank or an AC load.

6. The system of claim 4, wherein, to dissipate the energy through each of the DC-DC converter and the AFE, the one or more processors are configured to direct a first portion of the energy from the battery system, through the DC-DC converter, towards the first electric system and a second portion of the energy from the battery system, through the AFE, towards the second electric system.

7. The system of claim 6 further comprising:
a first switch that couples the DC-DC converter with the battery system; and
a second switch that couples the DC-DC converter with the first electric system, wherein the one or more processors are further configured to dispose each of the first switch and the second switch in an open state to dissipate the energy, through the DC-DC converter, towards the first electric system.

8. The system of claim 7 further comprising:
a third switch that couples the second electric system with the AFE, wherein the one or more processors are further configured to dispose each of the first switch in the open state and the third switch in an open state to dissipate the energy, through the AFE, towards the second electric system.

9. The system of claim 8, wherein the one or more processors are further configured to dispose each of the first switch, the second switch, and the third switch in the open state to direct the first portion of the energy towards the first electric system and the second portion of the energy towards the second electric system.

10. The system of claim 1, wherein, to dissipate the energy through both of the first semiconductor device and the second semiconductor device, the one or more processors are configured to control both of the first semiconductor device and the second semiconductor device to dissipate the energy through switching and conduction loss.

11. The system of claim 1 further comprising:
a grid coupled with the AFE; and
a fourth switch that couples the grid with the AFE, wherein the one or more processors are further configured to control the fourth switch to at least one of charge the battery system through the grid and to dissipate the energy stored in the battery system.

12. A method for dissipating energy stored in a battery system, the method comprising:
determining, by one or more processors of a controller, a current state of charge (SOC) of the battery system;
retrieving, from one or more memories of the controller, a minimum energy value that is to be maintained in the battery system, wherein the one or more memories are communicably coupled to the one or more processors;
comparing, by the one or more processors, the current SOC of the battery system with the minimum energy value; and
controlling, by the one or more processors, dissipation of the energy stored in the battery system if the current SOC is greater than the minimum energy value through at least one of:
a direct current DC-DC converter that is coupled with the battery system;
an active front end (AFE) that is coupled with the battery system and the DC-DC converter;
both of the DC-DC converter and the AFE; and
both of a first semiconductor device of the DC-DC converter and a second semiconductor device of the AFE.

13. The method of claim 12, wherein the DC-DC converter is coupled with the battery system via a first switch, and wherein the DC-DC converter is coupled with a first electric system via a second switch, the method further comprising:
operating, via the one or more processors, each of the first switch and the second switch in an open state; and
dissipating the energy, through the DC-DC converter, towards the first electric system based on the operation of each of the first switch and the second switch in the open state.

14. The method of claim 13, wherein the AFE is coupled with a second electric system via a third switch, the method further comprising:
operating, via the one or more processors, the first switch in the open state and the third switch in an open state; and
dissipating the energy, through the AFE, towards the second electric system based on the operation of each of the first switch and the third switch in the open state.

15. The method of claim 14 further comprising operating, via the one or more processors, each of the first switch, the second switch, and the third switch in an open state to direct a first portion of the energy, through the DC-DC converter, towards the first electric system and a second portion of the energy, through the AFE, towards the second electric system.

16. A controller for a battery system, the controller comprising:
one or more memories, wherein the one or more memories are configured to store a minimum energy value that is to be maintained in the battery system; and
one or more processors communicably coupled to the one or more memories, wherein the one or more processors are configured to perform the steps of:
determining a current state of charge (SOC) of the battery system;
retrieving, from the one or more memories, the minimum energy value that is to be maintained in the battery system;
comparing the current SOC of the battery system with the minimum energy value;
controlling dissipation of energy stored in the battery system if the current SOC is greater than the minimum energy value through at least one of:
a direct current (DC)-DC converter that is coupled with the battery system;
an active front end (AFE) that is coupled with the battery system and the DC-DC converter;
both of the DC-DC converter and the AFE; and
both of a first semiconductor device of the DC-DC converter and a second semiconductor device of the AFE.

17. The controller of claim 16, wherein the DC-DC converter is coupled with the battery system via a first switch, wherein the DC-DC converter is coupled with a first electric system via a second switch, and wherein the one or more processors are further configured to perform the steps of:
operating each of the first switch and the second switch in an open state to dissipate the energy, through the DC-DC converter, towards the first electric system.

18. The controller of claim 17, wherein the AFE is coupled with a second electric system via a third switch, and wherein the one or more processors are further configured to perform the steps of:
operating the first switch in the open state and the third switch in an open state to dissipate the energy, through the AFE, towards the second electric system.

19. The controller of claim 18, wherein the one or more processors are further configured to perform the steps of:
operating each of the first switch, the second switch, and the third switch in an open state to direct a first portion of the energy, through the DC-DC converter, towards the first electric system and a second portion of the energy, through the AFE, towards the second electric system.

20. The controller of claim 16, wherein the AFE is coupled with a grid via a fourth switch, and wherein the one or more processors are further configured to perform the steps of:
controlling the fourth switch to at least one of charge the battery system through the grid and to dissipate the energy stored in the battery system.
